(19) United States
(12) Patent Application Publication
(10) Pub. No.: US 2019/0063498 A1
(43) Pub. Date: Feb. 28, 2019

(54) Plain Bearing And Method For Producing The Same

(71) Applicant: RENK AG, Augsburg (DE)

(72) Inventors: Christoph HENTSCHKE, Hannover (DE); Burkhard PINNEKAMP, Augsburg (DE); Alexander UNGER, Hannover (DE)

(21) Appl. No.: 16/115,075

(22) Filed: Aug. 28, 2018

(30) Foreign Application Priority Data
Aug. 29, 2017 (DE) 102017119728.1

(51) Int. Cl. F16C 33/20; F16C 17/02

(52) U.S. Cl. CPC F16C 33/203; F16C 2208/32; F16C 2208/36; F16C 17/02

(57) ABSTRACT

A plain bearing, with a bearing base body of a metallic material and a plain bearing layer of a non-metallic material. The plain bearing layer is applied to the bearing base body either directly or indirectly via an intermediate layer of a metallic material applied to the bearing base body. The bearing base body of the metallic material or the intermediate layer of the metallic material is produced from an austenitic steel or from a metal alloy. The plain bearing layer of the non-metallic material is produced from polyetheretherketone (PEEK) or from polytetrafluoroethylene (PTFE).

### BACKGROUND OF THE INVENTION

### 1. Field of the Invention

The invention relates to a plain bearing and to a method for producing a plain bearing.

### 2. Description of the Related Art

Plain bearings known from practice typically comprise a bearing base body of a metallic material, to which is applied a plain bearing layer of a likewise metallic material either directly or indirectly via an intermediate layer. With plain bearings known from practice, the bearing base body is typically produced from steel and the plain bearing layer typically produced from a white metal or bronze. With plain bearings known from practice, a white metal material or a bronze material is sprayed into the basic bearing body or the intermediate layer applied to the bearing base body in order to ensure good adhesion of the plain bearing layer.

Although plain bearings known from practice have good properties with regard to desired sliding properties and desired wear resistance, there is a need for further improving their properties. For this reason, tests for replacing plain bearing layers of metallic materials with plain bearing layers of a non-metallic material are already being undertaken.

However, there is either the problem that the non-metallic material for the plain bearing layer does not provide the desired plain bearing properties or the method for producing such a plain bearing is too expensive.

### SUMMARY OF THE INVENTION

One aspect of the present invention is creating a new type of plain bearing with improved properties and a method for the simple production of the plain bearing.

The bearing base body of the metallic material or the intermediate layer of the metallic material is produced from an austenitic steel or from a metal alloy for example Cu, Cr, Zr. The plain bearing layer is produced from the non-metallic material, for example from polyetheretherketone (PEEK) or from polytetrafluoroethylene (PTFE). A plain bearing with such a base body, such an intermediate layer and such a plain bearing layer does not only possess desired plain bearing properties, but such a plain bearing can also be produced with little expenditure.

Preferentially, the bearing base body or the intermediate layer is produced from a metal alloy, namely from a Cu, Cr, Zr1 alloy with 0.5% by weight to 1.2% by weight of Cr, 0.03% by weight to 0.3% by weight of Zr and with Cu in the remainder. In particular when the bearing base body or the intermediate layer is produced from such a copper-chromium material, advantageous plain bearing properties with high heat conductivities can be provided. The plain bearing can also be particularly easily and advantageously produced through selective laser melting (SLM) with the help of a generative production method.

Preferentially, the bearing base body, adjacent to the plain bearing layer or the intermediate layer adjacent to the plain bearing layer has contours, in particular undercuts, in which the material of the plain bearing layer engages. By way of this, an improved form-fit joining of the plain bearing layer of the non-metallic material to the intermediate layer or the bearing base body can be achieved.

The intermediate layer is formed as SLM intermediate layer in particular when the plain bearing layer is directly applied via the intermediate layer onto the bearing base body, whereas the bearing base body is formed as SLM component in particular when the plain bearing layer is directly applied to the bearing base body.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Preferred further developments of the invention are obtained from the subclaims and the following description. Exemplary embodiments of the invention are explained in more detail by way of the drawing without being restricted to this.

There it shows:

FIG. 1: is a schematic extract from a plain bearing according to the invention;

FIG. 2: is a detail II of FIG. 1; and

FIG. 3: is a detail III of FIG. 1.

### DETAILED DESCRIPTION OF THE PRESENTLY PREFERRED EMBODIMENTS

The invention relates to a plain bearing and to a method for producing a plain bearing.

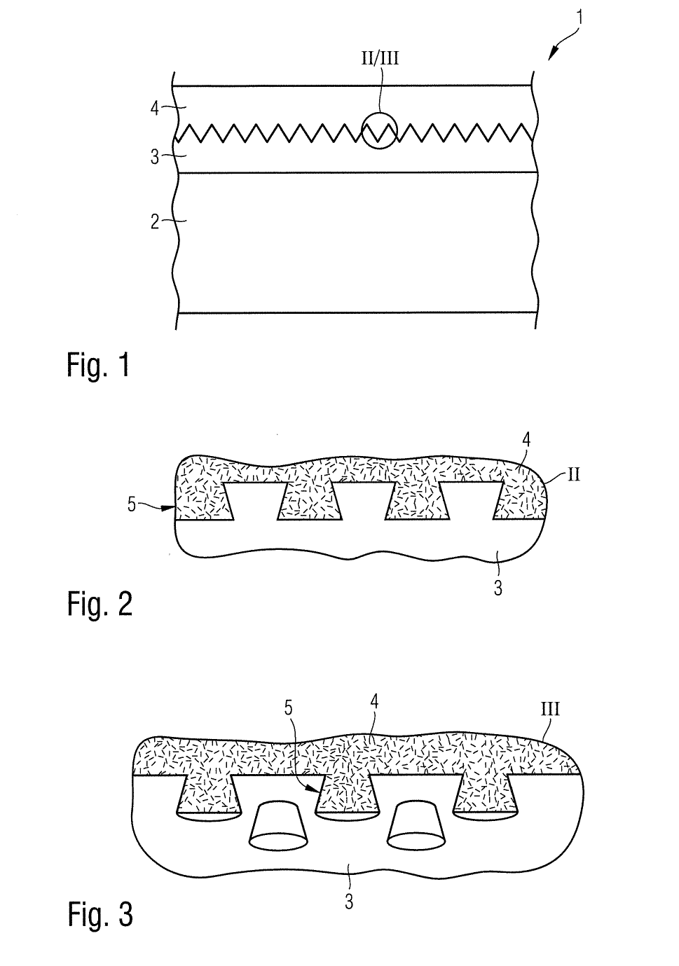

FIG. 1 shows, highly schematically, the construction of a preferred exemplary embodiment of a plain bearing 1 according to one aspect of the invention, wherein the plain bearing 1 of FIG. 1 comprises a bearing base body 2 of a metallic material, an intermediate layer 3 applied to the bearing base body 2 likewise of a metallic material and a plain bearing layer 4 of a non-metallic material, wherein the plain bearing layer 4 of the non-metallic material is applied to the intermediate layer 3.

The intermediate layer 3 applied to the bearing base body 2 is a layer of a metallic material, namely of an austenitic steel or of a metal alloy.

The plain bearing layer 4 of the non-metallic material is for example a plain bearing layer of polyetheretherketone (PEEK) or of polytetrafluoroethylene (PTFE).

In the exemplary embodiment show in FIG. 1, the intermediate layer 3 is formed as an SLM intermediate layer, which is applied to the bearing base body 2 via selective laser melting and accordingly via a generative production method.

Here, the intermediate layer 3 provides a contour 5 of preferentially undercuts adjacently to the plain bearing layer 4, into which the material of the plain bearing layer 4 engages, wherein in FIG. 2 the undercuts are provided by dovetail-like contours 5 and in FIG. 3 the undercuts are provided by conical contours 5. Honeycomb-like, waffle-like, lattice-like or other contours 5 forming undercuts can also be formed in the region of the intermediate layer 3 adjacently to the plain bearing layer 4.

The plain bearing layer 4, which is produced from polyetheretherketone or of polytetrafluoroethylene is preferentially applied to the intermediate layer 3 by melting on or melting in, in particular with engaging behind the undercuts 5.

The intermediate layer 3, which is produced from the metallic material, is preferentially produced from a metal alloy, particularly preferably from a CuCrZr1 alloy.

The CuCrZr1 alloy preferentially comprises 0.5% by weight to 1.2% by weight of Cr, 0.03% by weight to 0.3% by weight of Zr and Cu in the remainder, with maximally permissible admixtures of Fe of up to 0.08% by weight, maximally permissible admixtures of Si of up to 0.1% by weight and other admixtures up to maximally permissible 0.2% by weight.

Accordingly, in the preferred exemplary embodiment of the invention, the intermediate layer 3, which is applied to the bearing base body 2, is formed as an SLM intermediate layer via selective laser melting and of a metallic material, namely of an austenitic steel or of a metal alloy. As metal alloy, a CuCrZr1 alloy and as austenitic steel preferentially an X5CrNi18-10 alloy are employed. In each case, the intermediate layer 3 is applied to the bearing base body 2 by selective laser melting, namely subject to forming contours which promote applying the plain bearing layer 4, wherein these contours 5 form in particular undercuts. The plain bearing layer 4 of the non-metallic material consists of an anti-friction material, preferentially high-temperature-resistant plastic, e.g. of polyetheretherketone or of polytetrafluoroethylene and is melted onto the intermediate layer 3, in particular melted into or pressed into the contour 5 of the intermediate layer 3.

In contrast with the exemplary embodiment shown in FIGS. 1 to 3 it is possible that the bearing base body 2 is embodied as an SLM component through selective laser melting. In this case, no separate intermediate layer 3 is present, but the plain bearing material of the plain bearing layer 3. For example, the polyetheretherketone or the polytetrafluoroethylene is directly applied to the SLM bearing base body 2, wherein the SLM bearing base body 2 forms the contours 5 with, in particular, undercuts on a surface facing the plain bearing layer 4. In this case, the bearing base body is produced from a metal alloy such as for example a CuCrZr1 alloy or from an austenitic steel such as for example an X5CrNi18-10 alloy.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A plain bearing, comprising:
a bearing base body of a metallic material; and
a plain bearing layer of a non-metallic material produced from polyetheretherketone (PEEK) or from polytetrafluoroethylene (PTFE), and is applied to the bearing base body one of:
directly to the bearing base body or
indirectly to the bearing base body via an intermediate layer of a metallic material,
wherein:
the bearing base body or the intermediate layer is produced from an austenitic steel or an electrode metal.

2. The plain bearing according to claim 1, wherein the bearing base body or the intermediate layer is produced from an electrode metal.

3. The plain bearing according to claim 1, wherein the bearing base body has contours into which the plain bearing layer engages.

4. The plain bearing according to claim 3, wherein the contours are contoured as one of dovetail-like, honeycomb-like, waffle-like, or conical.

5. The plain bearing according to claim 1, wherein the bearing base body is an SLM component.

6. The plain bearing according to claim 1, wherein the intermediate layer is an SLM intermediate layer.

7. A plain bearing, comprising:
a bearing base body of a metallic material; and
a plain bearing layer of a non-metallic material applied to the bearing base body one of:
directly to the bearing base body or
indirectly to the bearing base body via an intermediate layer of a metallic material,
wherein:
when the plain bearing layer is applied indirectly to the bearing base body via the intermediate layer, the intermediate layer is an SLM intermediate layer, and
when the plain bearing layer is applied directly to the bearing base body, the bearing base body is an SLM component.

8. A method for producing a plain bearing, comprising:
providing a bearing base body of a metallic material is provided;
applying an intermediate layer of the metallic material is applied to the bearing base body via selective laser melting; and
applying a plain bearing layer of a non-metallic material to the intermediate layer by melting-on or melting-in.

9. A method for producing a plain bearing, comprising:
producing a bearing base body via selective laser melting; and
applying a plain bearing layer of non-metallic material to the bearing base body by melting-on or melting-in.

10. The method for producing a plain bearing according to claim 9, wherein
the plain bearing layer is introduced in parallel or sequentially to production of the bearing base body and an intermediate layer by an additive production method.

11. The plain bearing according to claim 2, wherein the electrode metal is a CuCrZr1 alloy with 0.5% by weight to 1.2% by weight of Cr, 0.03% by weight to 0.3% by weight of Zr and with Cu in a remainder.

12. The plain bearing according to claim 3, wherein the contours are undercuts.
